(19) United States
(12) Patent Application Publication
(10) Pub. No.: US 2019/0261688 A1
(43) Pub. Date: Aug. 29, 2019

(54) BAKING TYPE HEATING ASSEMBLY, AEROSOL GENERATING DEVICE AND ELECTRONIC CIGARETTE

(71) Applicant: Changzhou Patent Electronic Technology Co., LTD, Changzhou (CN)

(72) Inventors: Weihua QIU, Changzhou (CN); Neng HUA, Changzhou (CN)

(21) Appl. No.: 16/286,257

(22) Filed: Feb. 26, 2019

(30) Foreign Application Priority Data
Feb. 26, 2018 (CN) 201820278657.8

(51) Int. Cl. A24F 47/00; H05B 3/12; H05B 3/42

(52) U.S. Cl. CPC A24F 47/008; H05B 2203/022; H05B 3/42; H05B 3/12

(57) ABSTRACT

A baking type heating assembly includes a first conductive heating member, and a second conductive heating member connected to the first conductive heating member. The second conductive heating member has a cavity for accommodating the tobacco material. The first conductive heating member has an intake passage therein, one end of the intake passage is in communication with the cavity, the opposite end of the intake passage is in communication with the outside air. The baking type heating assembly is directly provided with an intake passage cooperating with the cavity of the second conductive heating member. Both the intake passage and the cavity heat the outside air entering the baking type heating assembly, which can provide a high heat transfer efficiency and a good heating effect.

### FIELD

The present disclosure relates to the technical field of electronic cigarettes, in particular to a baking type heating assembly, an aerosol generating device and an electronic cigarette.

### BACKGROUND

Baking type electronic cigarettes generally use an aerosol generating device to store tobacco materials. The tobacco material is baked to form smoke by heating the aerosol generating device. The user sucks on the mouthpiece, draws outside air into the electronic cigarette and carries the smoke out of the aerosol generating device, and finally the smoke enters the user's mouth.

### SUMMARY

The present disclosure provides a baking type heating assembly, an aerosol generating device and an electronic cigarette thereof. The baking type heating assembly has the functions of a heating element and air passage, high heat transfer efficiency, and good heating effect; the aerosol generating device having the baking type heating assembly has a better overall effect, and can improved the user experience.

A baking type heating assembly includes a first conductive heating member, and a second conductive heating member connected to the first conductive heating member, the second conductive heating member is provided with a cavity for accommodating the tobacco material, the first conductive heating member is provided with an intake passage therein, one end of the intake passage is in communication with the cavity, the opposite end of the intake passage is in communication with the outside air.

In one embodiment, the intake passage is a tortuous channel that reciprocates back and forth.

In one embodiment, one end of the first conductive heating member away from the second conductive heating member is connected to a first electrode.

In one embodiment, the tortuous channel includes at least two air passages that are parallel to each other, one end of the first conductive heating member and/or the second conductive heating member are provided with at least one first steering groove, the opposite end of the first conductive heating member and/or the first electrode are provided with at least one second steering groove, the first steering groove and the second steering groove respectively form as an air reversing chamber between adjacent air passages.

In one embodiment, the tortuous channels are arranged in parallel, or the tortuous channels is divergent outward from a point of the second electrically conductive heating member, a same air inlet channel is shared between at least two tortuous channels, or the tortuous airway does not share the air inlet channel.

In one embodiment, the first conductive heating member comprises a porous member, the intake passage is formed by through hole of the porous member

In one embodiment, the porous member is formed by stacking a plurality of layers of mesh.

In one embodiment, the first conductive heating member is made of metal conductive ceramic or metal.

An aerosol generating device includes a housing and any one of the above baking type heating assembly located in the housing, the bottom portion of the housing is connected with a base; the baking type heating assembly comprises a first conductive heating member, and a second conductive heating member connected to the first conductive heating member, the second conductive heating member is provided with a cavity for accommodating the tobacco material, the first conductive heating member is provided with an intake passage therein, one end of the intake passage is in communication with the cavity, the opposite end of the intake passage is in communication with the outside air, the housing is provided with an air outlet in communication with the cavity, the base is provided with a through hole in communication with the intake passage.

In one embodiment, the housing is an insulating outer casing, and the base is an insulating base.

In one embodiment, one end of the first conductive heating member away from the second conductive heating member is connected to a first electrode, the base is provided with a mounting groove therein for receiving the first electrode.

In one embodiment, the bottom of the mounting groove is provided with a through hole.

In one embodiment, the outer wall of the base comprises a connecting portion and a supporting portion, the diameter of the connecting portion is less than the diameter of the support portion, the connecting portion and the housing are screwed together.

In one embodiment, a limiting ring is disposed at the air outlet at the top of the housing, the top end of the second conductive heating member abuts against the bottom surface of the limiting ring.

An electronic cigarette includes any one of the above aerosol generating devices.

In one embodiment, the tortuous channels are arranged in parallel, or the tortuous channels is divergent outward from a point of the second electrically conductive heating member, the same air inlet channel is shared between at least two tortuous channels, or the tortuous airway does not share the air inlet channel.

In one embodiment, the intake passage is a tortuous channel that reciprocates back and forth.

In one embodiment, the tortuous channel includes at least two air passages that are parallel to each other, one end of the first conductive heating member and/or the second conductive heating member are provided with at least one first steering groove, the opposite end of the first conductive heating member and/or the first electrode are provided with at least one second steering groove, the first steering groove and the second steering groove respectively form as an air reversing chamber between adjacent air passages.

The beneficial effects of the device are:

The baking type heating assembly is directly provided with an intake passage cooperating with the cavity of the second conductive heating member. Both the intake passage and the cavity heat the outside air entering the baking type heating assembly, which can provide a high heat transfer efficiency and a good heating effect; the overall structure is simple and compact, easy to assemble and reduces production cost. The aerosol generating device having the baking type heating assembly has a better overall effect, and can improved the user experience.

### BRIEF DESCRIPTION OF THE DRAWINGS

FIG. 1 is a schematic view of an aerosol generating device of the present disclosure;

FIG. 2 is a cross-sectional view of the aerosol generating device of FIG. 1 in the A-A direction;

FIG. 3 is a top plan view of the aerosol generating device shown in FIG. 1;

FIG. 4 is an exploded perspective view of the aerosol generating device shown in FIG. 1;

FIG. 5 is an exploded perspective view of the aerosol generating device shown in FIG. 4;

The following table list various components and reference numerals thereof.

| | |
|---|---|
| Second conductive heating member 1 | First air passages 321 |
| Cavity 11 | Second air passages 322 |
| Circular protrusion 12 | Third air passages 323 |
| First annular protrusion 13 | Circular groove 33 |
| Communicating hole 131 | First annular groove 34 |
| First electrode 2 | Second annular groove 35 |
| Air inlet hole 21 | Housing 44 |
| Second annular protrusion 22 | Air outlet 41 |
| Positioning protrusion 23 | Limiting ring 42 |
| First conductive heating member 3 | Base 5 |
| Main body 31 | Through hole 51 |
| Intake passage 32 | Mounting groove 52 |
| Connecting portion 53 | Supporting portion 54 |

### DETAILED DESCRIPTION OF PREFERRED EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

When a feature or element is herein referred to as being “on” another feature or element, it can be directly on the other feature or element or intervening features and/or elements may also be present.

Terminology used herein is for the purpose of describing particular embodiments only and is not intended to be limiting of the disclosure. As used herein, the term “and/or” includes any and all combinations of one or more of the associated listed items and may be abbreviated as “/”.

### The First Embodiment

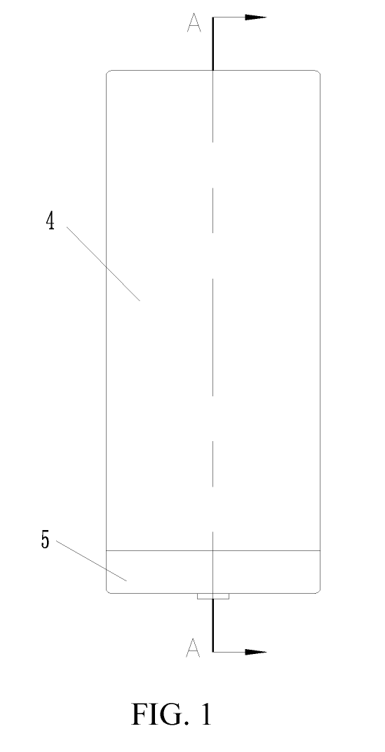

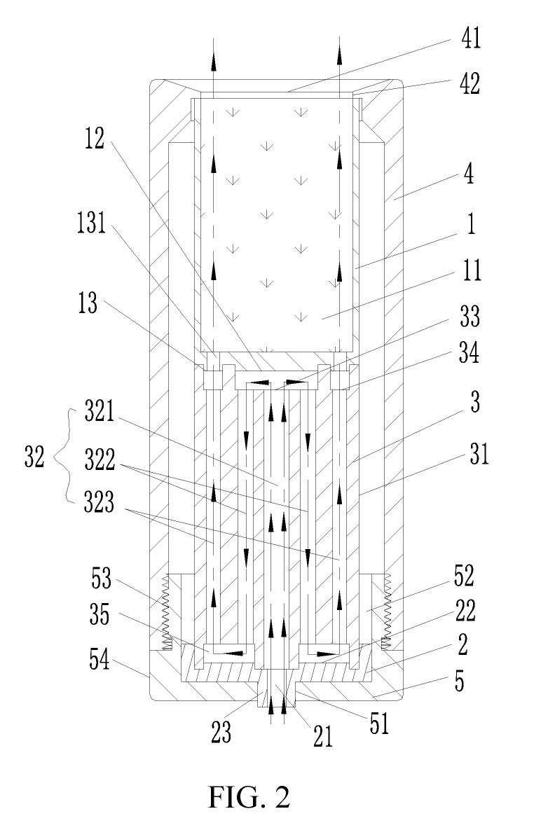

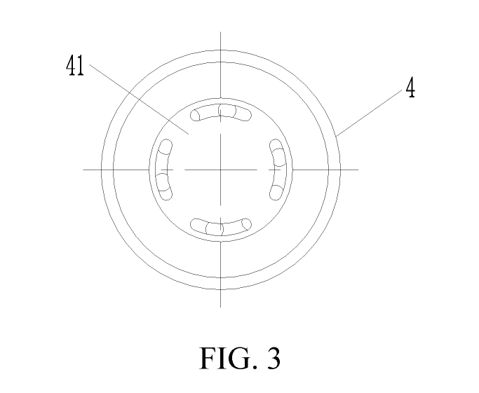

As shown in FIG. 1, FIG. 2 and FIG. 3, a baking type heating assembly includes a first conductive heating member 3, the upper portion of the first conductive heating member 3 is connected to a second conductive heating member 1, the lower portion of the first conductive heating member 3 is connected to the first electrode 2. The second conductive heating member 1 is provided with a cavity 11 for accommodating the tobacco material, the first electrode 2 is provided with an air inlet hole 21, an intake passage 32 is disposed in the first conductive heating member 3. The cavity 11 and the air inlet hole 21 are both in communication with the intake passage 32, the air inlet hole 21 is in communication with the outside air. The outside air enters the intake passage 32 from the air inlet hole 21, and then enter the cavity 11 of the second conductive heating member 1 after being heated in the intake passage 32, finally, the heated air flows out of the cavity 11 along with the smoke generated by the tobacco after baking. It is to be understood that, the tobacco material includes, but is not limited to, tobacco shred, tobacco paste, and tobacco cake. In the embodiment, the intake passage 32 is a tortuous channel that reciprocates back and forth, which can increase the flow time of the airflow in the passage, increase the contact area of the airflow and the passage, facilitate the heating of the airflow, and enhance the heating effect of the airflow.

The number of the tortuous channel is one or more. The tortuous channel includes at least two air passages arranged in parallel, the air passages is in communication with each through steering groove(s). In this embodiment, one end of the first conductive heating member 3 and/or the second conductive heating member 1 are provided with at least one first steering groove, the opposite end of the first conductive heating member 3 and/or the first electrode 2 are provided with at least one second steering groove. The first steering groove and the second steering groove respectively form as an air reversing chamber between adjacent air passages. That is, the first steering groove and the second steering groove are both used to connect adjacent air passages, to achieve air commutation between adjacent air passages. The tortuous channels are arranged in parallel, or the tortuous channels is divergent outward from a point of the second conductive heating member 1. A same air inlet channel is shared between at least two tortuous channels, or the tortuous airway does not share the same air inlet channel.

In one embodiment, in the radial cross-section of the baking type heating assembly, the air passages are arranged in the circumferential direction.

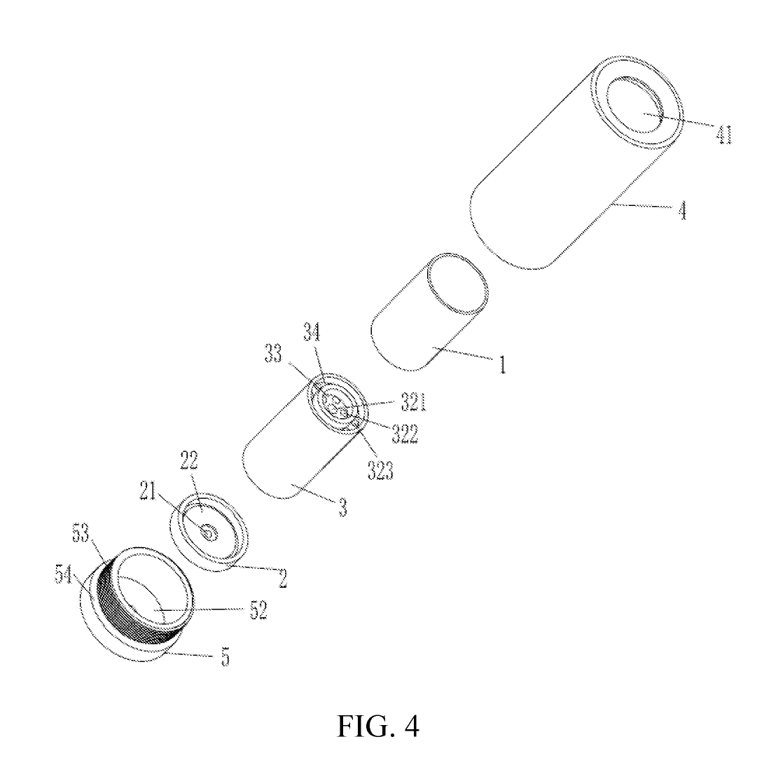

As shown in FIG. 2 and FIG. 4, the first conductive heating member 3 has a substantially cylinder shape. A plurality of groups of air passages are arranged in the radial direction from the outermost side to the innermost side of the first conductive heating member 3, each group of air passages is disposed along the axial direction of the first conductive heating member 3. In the embodiment, the innermost group of air passages is in communicate with the air inlet holes 21, the outermost group of air passages is in communicate with the cavity 11. It can be understood that, in other embodiments, the innermost group of the air passages is in communication with the cavity 11, the outermost group of the air passages is in communicate with the air inlet holes 21. Further, the shape of the first conductive heating member 3 is not limited, in other embodiments, the first conductive heating member 3 has a shape such as a rectangular parallelepiped, a prism, or the like. It can be understood that, the innermost group of air passages and the outermost group of air passages have only one group of adjacent air passage, respectively; each group of air passages located between the innermost and outermost air passages has adjacent two groups of air passages and are connected to the adjacent two groups of air passages respectively.

A partition wall is arranged between adjacent two groups of air passages, in each of the two adjacent partition walls, one end of one of the partition walls abuts against the second conductive heating member 1, there is a gap between the other end of the partition wall and the first electrode 2. One end of the other partition wall abuts against the first electrode 2, a gap is formed between the other end of the other partition wall and the second conductive heating member 1.

Both the first steering groove and the second steering groove have two opposite corners. The corner is surrounded by the second conductive heating member 1 and/or the first electrode 2 and the partition wall, and the two corners is in communication with each other through the gap between the partition wall and the second conductive heating member 1 and/or the first electrode 2. When the airflow flows along an air passage, first enters a corner, and then passes through the gap between the partition wall and the second conductive heating member 1 or/and first electrode 2 to enter another corner, and passes through the another corner to enter another adjacent air passages to achieve airflow steering. It can be understood that, the corner is a right angle corner or a round corner.

In one embodiment, the second conductive heating member 1 has a substantially cylindrical structure and provides a cavity therein. The second conductive heating member 1 further provide an opening away from the first conductive heating member, the smoke generated by baking flows out from the opening.

In one embodiment, the first electrode 2 is substantially disk-shaped, and abuts against and is electrically connected to the first conductive heating member 3. In other embodiments, the first electrode 2 may be integrally formed with the first conductive heating member 3.

The tortuous channel includes at least two air passages that are parallel to each other. The number of the tortuous channel is one or more. In this embodiment, the tortuous channel includes a first air passage 321, a second air passage 322 and a third air passage 323. In one tortuous channel, the air inlet of the first air passage 321 is in communication with the air inlet hole 21, the air outlet of the first air passage 321 is in communication with the air inlet of the second air passage 322. The air outlet of the second air passage 322 is in communication with the air inlet of the third air passage 323. The air outlet of the third air passage 323 is in communication with the cavity 11 of the second conductive heating member 1. It can be understood that, in other embodiments, the tortuous channel may include two or more air passages, such as the tortuous channel has a first air passage 321, a second air passage 322, a third air passage 323 and a fourth air passage, or further includes a fifth air passage.

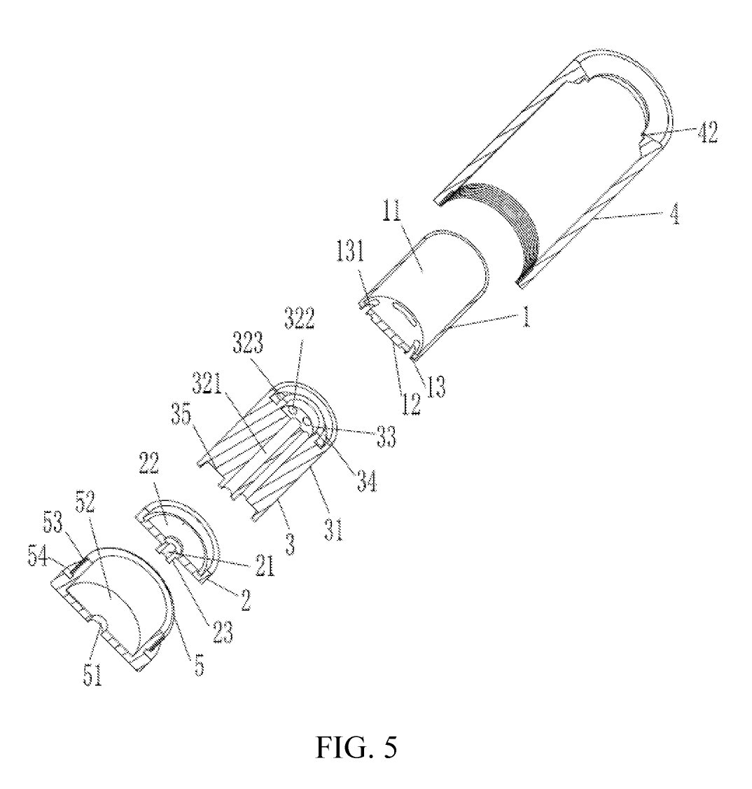

As shown in FIG. 4 and FIG. 5, the first steering groove is a circular groove 33, the second steering groove is a second annular groove 35, the first conductive heating member 3 includes a main body 31. In the embodiment, the main body 31 has a cylinder shape. The top portion of the main body 31 is provided with a circular groove 33 and a first annular groove 34. A circular groove 33 is located in the middle of the top portion of the main body 31. The first annular groove 34 is located near the outer wall of the main body 31. A second annular groove 35 is defined in the bottom of the main body 31. The second conductive heating member 1 is provided with a circular protrusion 12 corresponding to the circular groove 33, the second conductive heating member 1 is further provided with a first annular protrusion 13 corresponding to the first annular groove 34. The first electrode 2 is provided with a second annular protrusion 22 corresponding to the second annular groove 35. The circular protrusion 12 is clamped at an end of the circular groove 33 away from the first electrode 2. The first annular protrusion 13 is clamped at an end of the first annular groove 34 away from the first electrode 2, the second annular protrusion 22 is clamped at one end of the second annular groove 35 away from the second conductive heating member 1.

In the embodiment, the number of the tortuous channel is two or more, that is, the number of first air passages 321, the second air passages 322 and third air passages 323 are two or more, respectively. In other embodiment, the number of first air passage 321 can be one, that is, the tortuous channels share the same first air passage 321. In other embodiments, the tortuous channel can also share other air passage, such as the third passage 323, as needed. The first air passages 321 are disposed in the middle of the circular groove 33. The second air passages 322 are disposed between the side walls of the circular groove 33 and the first air passages 321, and the second air passages 322 are circumferentially disposed. The third air passages 323 arranged circumferentially are disposed in the second annular groove 35. The first air passages 321, the second air passages 322 and the third air passages 323 extend through the main body 31 in the axial direction of the main body 31, respectively. It can be understood that, to ensure that the air outlet of the first air passages 321 is in communication with the air inlet of the second air passages 322, the air outlets of the second air passages 322 is in communication with the air inlets of the third air passages 323; the gap between the circular groove 33 and the circular protrusion 12 is configured for airflow reversing, the gap between the second annular groove 35 and the second annular protrusion 22 is configured for airflow reversing. Specifically, there are the following two implementation manners. In a first embodiment, the circular protrusion 12 is partially clamped at one end of the circular groove 33 away from the first electrode 2, the second annular protrusion 22 is partially clamped at one end of the second annular groove 35 away from the second conductive heating member 1; for example, a metal spacer is electrically connected between the second conductive heating member 1 and the first conductive heating member 3, and the metal spacer forms a gap therebetween for gas commutation. In a second embodiment, the height of the circular protrusion 12 is less than the depth of the circular groove 33, the height of the second annular protrusion 22 is less than the depth of the second annular groove 35. Both of the above two embodiments can form a gap between the circular protrusion 12 and the circular groove 33 for the airflow to enter the air inlet of the second air passage 322 from the air outlet of the first air passage 321, and a gap between the second annular protrusion 22 and the second annular groove 35 for the airflow to enter the air inlet of the third air passage 323 from the air outlet of the second air passage 322. In addition, the first annular protrusion 13 can also be used in the same manner. That is, the first annular protrusion 13 is partially clamped at one end of the first annular groove 34 away from the first electrode 2, or making the height of the first annular protrusion 13 less than the depth of the first annular groove 34, to facilitate processing and improve the air intake effect.

It can be understood that, the circular protrusion 12 and the circular groove 33 are connected by a clamping connection, which can increase the stability and reliability of the structure. However, the two are not limited to this type of connection, the circular protrusion 12 can be butte against the circular groove 33 by pressing. Similarly, the second annular protrusion 22 can be butte against the second annular groove 35 by pressing.

In the above embodiment, the first steering groove and the second steering groove are both defined on the main body 31, the first steering groove can be defined on the second conductive heating member 1 and the second steering groove can be defined on the first electrode 2. Or, a groove is formed in each of the top ends of the second conductive heating member 1 and the main body 31, the two grooves are butted to form a complete first steering groove. Similarly, the bottom end of the first electrode 2 and the bottom end of the main body 31 are provided with a groove, and the two grooves are butted to form a second steering groove.

The first annular protrusion 13 is provided with a communicating hole 131, the communicating hole 131 is in communication with the inside of the cavity 11. The air outlet of the third air passage 323 is in communication with the cavity 11 through the communicating hole 131.

In one embodiment, as shown in FIG. 5, the first annular protrusion 13 is provided with a plurality of communicating hole 131 circumferentially disposed, so that the airflow enters from the circumferential direction, the effect of the intake air and the flow effect of the airflow within the cavity 11 are enhanced.

It can be understood that, the shapes of the first steering groove and the second steering groove are not limited to a cylindrical shape, other shapes such as a rectangular parallelepiped, a taper, or the like may be employed as needed.

In one embodiment, the communicating hole 131 is an arc hole, which is convenient for processing and is more convenient for improving the flow effect of the airflow in the cavity 11.

In one embodiment, the first air passage 321, the second air passage 322, and the third air passage 323 are tubular, respectively. In order to ensure the amount of intake air entering the first air passage 321 from the air inlet hole 21, the diameters of the first air passage 321 are larger than the diameters of the second air passage 322 and the third air passage 323. It is to be understood that, the shapes of the first air passage 321, the second air passage 322, and the third air passage 323 are not limited to a circular tube shape, other shapes such as a square tube shape may be employed as needed.

In one embodiment, the intake passage 32 is a serpentine passage that reciprocates back and forth.

In one embodiment, the intake passage 32 is a helical passage.

In one embodiment, the first conductive heating member 3 is a conductive ceramic. Further, the conductive ceramic is a metal conductive ceramic, and the metal conductive ceramic is a composite material composed of a ceramic hard phase and a metal or alloy bonded phase. Thereby, it not only maintains the high strength, high hardness, wear resistance, high temperature resistance, oxidation resistance and chemical stability of ceramics, but also has good toughness, electrical conductivity and elasticity of metal. It is to be understood that, in other embodiments, the first conductive heating member 3 can be made of metal material such as copper or aluminum.

In this embodiment, the baking type heating assembly is provided with an intake passage 32, and through the cooperation of the second conductive heating member 1 and the first electrode 2, the baking type heating assembly has the functions of heating element and air passage, high heat transfer efficiency and good heating effect; the overall structure is simple and compact, easy to assemble and reduces production cost.

The embodiment also provides an aerosol generating device. As shown in FIG. 1 to FIG. 5, the aerosol generating device includes a housing 4, the bottom portion of the housing 4 is connected with a base 5, the housing 4 is provided with the baking type heating assembly, the housing 4 is provided with an air outlet 41 in communication with the cavity 11. The first electrode 2 is connected to the base 5, the base 5 is provided with a through hole 51 in communication with the air inlet hole 21. It can be understood that, the tobacco material is received in the cavity 11 of the second conductive heating member 1, the second conductive heating member 1 is also function as the holder of the aerosol generating device. The second conductive heating member 1 can be made of the same material as the first conductive heating member 3 or a conductive material different from the first conductive heating member 3. In one embodiment, the second conductive heating member 1 is made of a copper aluminum alloy.

Alternatively, the housing 4 is an insulating outer casing, and the base 5 is an insulating base, to provide an insulation effect to ensure safety of the user. The base 5 and the housing 4 are screwed together.

The bottom of the first electrode 2 is provided with a positioning protrusion 23, the shape of the positioning protrusion 23 is adapted to the shape of the through hole 51. An air inlet hole 21 is disposed in the positioning protrusion 23, the positioning protrusion 23 is clamped in the through hole 51.

In one embodiment, the base 5 is provided with a mounting groove 52 therein for receiving the first electrode 2. The bottom of the mounting groove 52 is provided with a through hole 51, the outer wall of the base 5 includes a connecting portion 53 and a supporting portion 54, the diameter of the connecting portion 53 is less than the diameter of the support portion 54. The connecting portion 53 and the housing 4 are screwed together. Thus, the connection between the housing 4 and the base 5, the base 5 and the first electrode 2 are more reliable and stable, and also facilitates assembly and disassembly.

In one embodiment, a limiting ring 42 is disposed at the air outlet 41 at the top of the housing 4, the top end of the second conductive heating member 1 abuts against the bottom surface of the limiting ring 42. The limiting 42 can better prevent the second conductive heating member 1 from slipping in the housing 4, and improve the mounting stability of the second conductive heating member 1. Specifically, the limiting ring 42 can be fixed to the air outlet 41 by means of a buckle. Alternatively, the limiting ring 42 and the air outlet 41 are integrally provided. That is, a latching ring projecting inward is formed as the limiting ring 42.

As shown in FIG. 2, the direction of the arrow in FIG. 2 is the direction of the airflow. The working principle of the aerosol generating device of this embodiment is as follows. The external air sequentially enters the first air passage 321, the second air passage 322, the third air passage 323 from the air inlet hole 21, and finally flowing out from the third air passage 323 and passing through the communicating hole 131 into the cavity 11 of the second conductive heating member 1. During this process, the second conductive heating member 1 and the first electrode 2 are energized, thereby, the second conductive heating member 1 used as the holder body is heated to allow the tobacco in the cavity 11 to be baked. At the same time, the heat generated by the first conductive heating member 3 also heats the air in the first air passages 321, the second air passages 322 and the third air passages 323. The heated air finally entering the cavity 11 of the second conductive heating member 1 flows out from the air outlet 41 of the cavity 11 together with the smoke generated by the baking of the tobacco material for the user to inhale.

### The Second Embodiment

The difference between this embodiment and the first embodiment is as follows. The first conductive heating member 3 includes a porous member. The intake passage 32 is formed by the through holes in the porous member, which can better increase the contact area of the air flow and the passage, and the flow time of the air flow in the passage, facilitate the sufficient uniform heating of the air flow to enhance the heating effect of the air flow.

In one of the embodiments, the porous member is made of a porous material to form dense pores. The porous material can be a porous metal material.

In one embodiment, the porous member is formed by stacking a plurality of layers of mesh. For example, the porous member can be laminated by a plurality of layers of metal mesh, the thickness and spacing of the laminate can be adjusted as needed.

An electronic cigarette is also provided in the embodiment, the electronic cigarette includes the aerosol generating device of any of the above embodiments, wherein the electronic cigarette has all the technical features of the aerosol generating device, so the electronic cigarette all technical effects of the aerosol generating device are included.

The electronic cigarette further includes a battery assembly electronically connected to the baking type heating assembly. When in use, the battery assembly provides electric energy to the second conductive heating member 1 and the first conductive heating member 3. In one embodiment, the electronic cigarette further includes a main housing having a receiving cavity. The battery assembly is located in the main housing, and the aerosol generating device is detachably received in the receiving cavity.

The above-mentioned embodiments merely represent several implementations of the present application, and the descriptions thereof are more specific and detailed, but they shall not be understood as a limitation on the scope of the present application. It should be noted that, for those of ordinary skill in the art, variations and improvements may still be made without departing from the concept of the present application, and all of which shall fall into the protection scope of the present application. Therefore, the scope of protection of the present application shall be subject to the appended claims.

What is claimed is:

1. A baking type heating assembly, comprising:
a first conductive heating member, and
a second conductive heating member connected to the first conductive heating member, the second conductive heating member is provided with a cavity for accommodating the tobacco material, the first conductive heating member is provided with an intake passage therein, one end of the intake passage is in communication with the cavity, the opposite end of the intake passage is in communication with the outside air.

2. The baking type heating assembly of claim 1, wherein the intake passage is a tortuous channel that reciprocates back and forth.

3. The baking type heating assembly of claim 2, wherein one end of the first conductive heating member away from the second conductive heating member is connected to a first electrode.

4. The baking type heating assembly of claim 3, wherein the tortuous channel includes at least two air passages that are parallel to each other, one end of the first conductive heating member and/or the second conductive heating member are provided with at least one first steering groove, the opposite end of the first conductive heating member and/or the first electrode are provided with at least one second steering groove, the first steering groove and the second steering groove respectively form as an air reversing chamber between adjacent air passages.

5. The baking type heating assembly of claim 4, wherein the tortuous channels are arranged in parallel, or the tortuous channels is divergent outward from a point of the second electrically conductive heating member, the same air inlet channel is shared between at least two tortuous channels, or the tortuous airway does not share the air inlet channel.

6. The baking type heating assembly of claim 4, wherein the first conductive heating member comprises a porous member, the intake passage is formed by through hole of the porous member

7. The baking type heating assembly of claim 6, wherein the porous member is formed by stacking a plurality of layers of mesh.

8. The baking type heating assembly of claim 1, wherein the first conductive heating member is made of metal conductive ceramic or metal.

9. An aerosol generating device, comprising:
a housing, the bottom portion of the housing is connected with a base; and
a baking type heating assembly located in the housing, the baking type heating assembly comprises a first conductive heating member, and a second conductive heating member connected to the first conductive heating member, the second conductive heating member is provided with a cavity for accommodating the tobacco material, the first conductive heating member is provided with an intake passage therein, one end of the intake passage is in communication with the cavity, the opposite end of the intake passage is in communication with the outside air, the housing is provided with an air outlet in communication with the cavity, the base is provided with a through hole in communication with the air inlet hole.

10. The aerosol generating device of claim 9, wherein the housing an insulating outer casing, and the base is an insulating base.

11. The aerosol generating device of claim 9, wherein one end of the first conductive heating member away from the second conductive heating member is connected to a first electrode, the base is provided with a mounting groove therein for receiving the first electrode.

12. The aerosol generating device of claim 11, wherein the bottom of the mounting groove is provided with a through hole.

13. The aerosol generating device of claim 9, wherein the outer wall of the base comprises a connecting portion and a supporting portion, the diameter of the connecting portion is less than the diameter of the support portion, the connecting portion and the housing are screwed together.

14. The aerosol generating device of claim 9, wherein a limiting ring is disposed at the air outlet at the top of the housing, the top end of the second conductive heating member abuts against the bottom surface of the limiting ring.

15. An electronic cigarette, comprising:
an aerosol generating device, the aerosol generating device comprises a housing and a baking type heating assembly, the bottom portion of the housing is connected with a base, the baking type heating assembly comprises a first conductive heating member, and a second conductive heating member connected to the first conductive heating member, the second conductive heating member is provided with a cavity for accommodating the tobacco material, the first conductive heating member is provided with an intake passage therein, one end of the intake passage is in communication with the cavity, the opposite end of the intake passage is in communication with the outside air, the housing is provided with an air outlet in communication with the cavity, the base is provided with a through hole in communication with the air inlet hole.

16. The electronic cigarette of claim 15, wherein the intake passage is a tortuous channel that reciprocates back and forth.

17. The electronic cigarette of claim 15, wherein the tortuous channel includes at least two air passages that are parallel to each other, the air passages is in communication with each through steering groove(s), the number of the tortuous channel is one or more.

18. The electronic cigarette of claim 15, wherein the tortuous channels are arranged in parallel, or the tortuous channels is divergent outward from a point of the second electrically conductive heating member, the same air inlet channel is shared between at least two tortuous channels, or the tortuous airway does not share the air inlet channel.

19. The electronic cigarette of claim 15, wherein the tortuous channel includes at least two air passages that are parallel to each other, one end of the first conductive heating member and/or the second conductive heating member are provided with at least one first steering groove, the opposite end of the first conductive heating member and/or the first electrode are provided with at least one second steering groove, the first steering groove and the second steering groove respectively form as an air reversing chamber between adjacent air passages.
